(19) United States
(12) Patent Application Publication
(10) Pub. No.: US 2025/0387823 A1
(43) Pub. Date: Dec. 25, 2025

(54) DIFFUSION LAYER FOR AN ELECTROCHEMICAL CELL AND METHOD FOR PRODUCING A DIFFUSION LAYER

(71) Applicant: Robert Bosch GmbH, Stuttgart (DE)

(72) Inventor: Kai Weeber, Heimsheim (DE)

(21) Appl. No.: 18/846,428

(22) PCT Filed: Mar. 23, 2023
(86) PCT No.: PCT/EP2023/057468

§ 371 Date: Sep. 12, 2024

(30) Foreign Application Priority Data
Apr. 7, 2022 (DE) 10 2022 203 467.8

(51) Int. Cl. B21D 28/26; B21D 28/34; H01M 8/0206

(52) U.S. Cl. CPC B21D 28/26; B21D 28/34; H01M 8/0206

(57) ABSTRACT

A method for producing a diffusion layer (5, 6) for an electrochemical cell, wherein the diffusion layer consists of a foil (5a, 6a) in which a plurality of holes are made by means of hydraulic punching.

### BACKGROUND

The present invention relates to a diffusion layer for an electrochemical cell and a method for producing a diffusion layer.

Fuel cells are electrochemical or galvanic cells that convert the chemical reaction energy of a continuously supplied fuel and an oxidizing agent into electrical energy; in electrolysis, the electrochemical process runs in the other direction. Bipolar plates and diffusion layers are essential components of fuel cells and electrolysis cells. Diffusion layers for electrochemical cells are known, for example, from DE10238860A1.

### SUMMARY

The purpose of the present invention is to increase the perforation rate of a diffusion layer.

The diffusion layer for an electrochemical cell is now produced using hydraulic punching. The diffusion layer therefore consists of a foil in which a plurality of holes are punched hydraulically. Several million holes are preferably made in the foil.

Hydraulic punching allows more holes to be made in the foil than was previously possible, which increases the perforation rate of the diffusion layer produced in this way compared to the prior art. This type of diffusion layer can improve the media supply for the electrochemical cell and increase the performance of the electrochemical cell. Hydraulic punching is still a very fast production process.

In advantageous embodiments, the foil is a metallic foil. Hydraulic punching is particularly suitable for metallic foils, as very high pressures can be achieved. Hydraulic punching is the preferred method with a pressure of at least 10,000 bar. Advantageously, the foil has a maximum thickness of 0.2 mm so that the holes can actually be pierced.

In advantageous embodiments, hydraulic punching is carried out as water punching. This is very easy and inexpensive to carry out due to the availability of water.

In advantageous designs, the holes have a maximum diameter of 20 μm. This can be realized with hydraulic punching. This allows the perforation rate and the homogenization of the perforations to be further increased. Both are important for increasing the performance of the electrochemical cell.

In advantageous production methods, the foil is clamped between a first die and a second die during punching. A plurality of through holes is formed in the first die corresponding to the plurality of holes. The through-holes are fluidically connected to a pressure vessel on one side and fluidically connected to the (later) holes on the other side. This applies pressure to each subsequent hole in the foil so that all holes are pierced accordingly.

In advantageous embodiments, a plurality of blind holes is formed in the second die corresponding to the plurality of holes, which are fluidically connected to the holes. Preferably, the blind holes are under a pressure at the start of the method which corresponds to atmospheric pressure at most. Before the holes are pierced, atmospheric pressure is applied to the blind holes so that the foil has a maximum pressure difference (top-bottom) at the positions of the subsequent holes and the local mechanical stress leads to the holes being pierced.

The invention also includes a diffusion layer which has several million holes. Preferably, the diffusion layer is produced using one of the above methods.

Advantageously, the holes have a maximum diameter of 20 μm. This achieves a high and homogeneous perforation rate.

The holes are preferably cylindrical. This optimizes the flow path towards the membrane or catalytic layer of the electrochemical cell and reduces the flow resistance. This is particularly true in comparison with quasi-stochastic perforations, such as diffusion layers made of nonwovens.

The diffusion layers according to the invention are particularly suitable for fuel cells and electrolysis cells.

### BRIEF DESCRIPTION OF THE DRAWINGS

Further measures that improve the invention are shown in the following description of various exemplary embodiments of the invention, which are shown schematically in the figures. All features and/or advantages resulting from the claims, the description, or the figures, including design details and spatial arrangements, can be essential to the invention both individually and in the various combinations.

Schematically shown are:

FIG. 1 shows a sectional view of a fuel cell known from the prior art, with only the essential regions shown.

FIG. 2 a sectional view of another fuel cell known from the prior art, with only the essential regions shown.

FIG. 3 a method of production for a diffusion layer according to the invention, wherein only the essential regions are shown.

### DETAILED DESCRIPTION

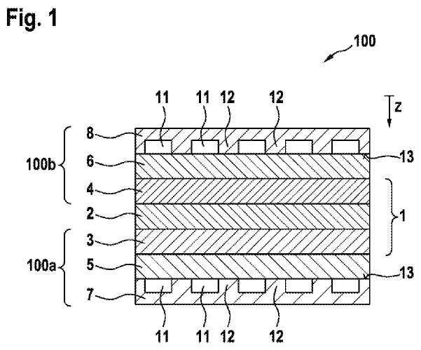

FIG. 1 schematically shows an electrochemical cell 100 known from the prior art in the form of a fuel cell, wherein only the essential regions are shown. The fuel cell 100 is designed as a PEM fuel cell and has a membrane 2, in particular a polymer electrolyte membrane. To one side of the membrane 2 a cathode space 100a is formed, to the other side an anode space 100b.

In the cathode space 100a, outwardly facing from the membrane 2—therefore in the normal direction or stacking direction z—an electrode layer 3, a diffusion layer 5, and a distributor plate 7 are arranged. An electrode layer 4, a diffusion layer 6, and a distributor plate 8 are in a similar manner arranged in the anode space 100b facing outwardly from the membrane 2. The membrane 2 and the two electrode layers 3, 4 form a membrane electrode assembly 1. Furthermore, the two diffusion layers 5, 6 can also be a component of the membrane electrode assembly 1.

The distributor plates 7, 8 have channels 11 for the gas supply—for example air in the cathode space 100a and hydrogen in the anode space 100b—to the gas diffusion layers 5, 6. The diffusion layers 5, 6 typically consist of a carbon fiber fleece on the channel side—i.e., towards the distributor plates 7, 8—and a microporous particle layer on the electrode side—i.e., towards the electrode layers 3, 4.

The distributor plates 7, 8 have the channels 11 and thus implicitly also ribs 12 adjacent to the channels 11. The undersides of these ribs 12 thus form a contact area 13 of the respective distributor plate 7, 8 to the underlying diffusion layer 5, 6.

The cathode-side distributor plate 7 and anode-side distributor plate 8 conventionally differ from each other. Preferably, the cathode-side distributor plate 7 of an electrochemical cell 100 and the anode-side distributor plate 8 of the electrochemical cell adjacent thereto are fixedly connected, for example by welded connections, and thus combined into a bipolar plate.

An electrochemical cell designed as an electrolytic cell can have a similar structure.

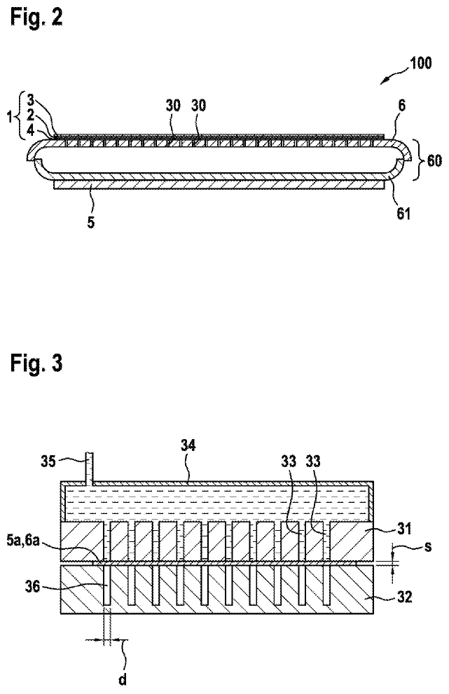

FIG. 2 schematically shows an electrochemical cell 100 known from DE10238860A1 in the form of a solid oxide fuel cell, wherein only the essential regions are shown. The diffusion layer 6 on the anode side is a metallic foil, which is also the so-called upper shell of a so-called cassette 60. As can be seen, this diffusion layer 6, which naturally extends over a certain length perpendicular to the drawing plane, is perforated, i.e., provided with holes 30. Together with a further structure known as the lower shell 61, the upper shell or diffusion layer 6 forms the cassette 60, which encloses a cavity. A metallic knitted wire mesh, for example, can be inserted into a partial region of this cavity, but this is not shown here. In their edge regions, the upper shell 6 and the lower shell 61 are welded together, i.e., connected to each other by a weld seam that runs all the way around and is therefore gas-tight.

The membrane-electrode arrangement 1 is applied to the outer side of the diffusion layer 6 facing away from the cavity, essentially in the overlapping region with the holes 30, wherein the layer in contact with the diffusion layer 6 is the electrode layer 4 on the anode side. This is applied in the production process of an electrochemical cell 100 as the first layer of a thermal powder spraying method. The electrolyte layer or membrane 2 and the cathode-side electrode layer 3 can then be applied to this.

The fuel gas required for the electrochemical cell 1 or for the electrochemical conversion process taking place in it is fed into the cavity of the cassette 60. Within the cavity, this fuel gas is suitably distributed to the individual holes 30 so that it can then pass through them to the electrode layer 4 on the anode side and react there accordingly.

In the version shown in FIG. 2, the cathode-side diffusion layer 5 is attached to the lower shell 61. Air or oxygen can then be fed through this diffusion algae 5 to the cathode-side electrode layer 3 of a neighboring electrochemical cell 100 not shown.

An analog structure also applies to an electrochemical cell 100 constructed as a solid oxide electrolysis cell.

The object of the invention is to increase the number of holes 30 of a diffusion layer 5, 6 of an electrochemical cell 100, preferably by a factor of 5-10. Ideally, the processing time should also be reduced at the same time. The invention can be used for all diffusion layers 5, 6 or functional layers of electrochemical cells 100, which are designed in a foil-like manner and should have a very high number of holes 30 in the foil thickness.

Previously, the holes 30 were made by laser in the metallic foil or in the diffusion layer 5, 6. This took several minutes per diffusion layer 5, 6 of a typical electrochemical cell 100. According to the invention, the foil to be perforated is now to be perforated by hydraulic punching, in particular by “water punching,” in a single step, preferably with several million holes 30, so that the diffusion layer 5, 6 is formed.

FIG. 3 shows a foil 5a, 6a to be processed, which is firmly clamped between two dies 31, 32. The first die 31 has through-holes 33, which can be fluidically connected to a pressure vessel 34. The pressure vessel 34 has a pressurized liquid or a liquid to be pressurized, preferably water. The liquid can, for example, be pressurized via an inflow 35, preferably even increased to a pressure of several thousand bar, particularly preferably to a pressure of more than 10,000 bar. The water pressure then acts on the foil 5a, 6a through the through-holes 33 and finally breaks through it, creating the holes 30 and with them the diffusion layer 5, 6.

The second die 32 has blind holes 36. At the beginning of the process, these blind holes 36 are preferably filled exclusively with a compressible medium, e.g., air, or even designed as a vacuum. After the breakthrough of a hole 30, the corresponding blind hole 36 fills with liquid and there is equal pressure only for the dedicated hole 30. This ensures that all holes 30 are pierced. If the blind holes 36 were continuous and had a fluidic connection in a collecting vessel, all the other holes of the second die 32 would fill up backwards after one hole 30 had broken through and an undesired equal pressure would occur. The blind holes 36 can therefore ensure that all the desired holes 30 are produced.

In preferred embodiments, the foil 5a, 6a or the diffusion layer 5, 6 has a maximum thickness s of 0.2 mm. The diameter d of the through holes 33 and blind holes 36—and thus also the diameter d of the holes 30 themselves—is preferably 20 μm or less.

The liquid in the pressure vessel is advantageously pressurized to at least 10,000 bar, so that the holes 30 can also be made in a stainless steel foil 5a, 6a, since the tensile strength of stainless steel is typically 70-80 kN/cm². The high pressure of 10,000 bar can preferably be generated by a hydraulic transmission. Since no high volume flows need to be generated, the cost is low.

The advantages of the methods and diffusion layers 5, 6 according to the invention are as follows:
Increased perforation rate with the same processing time.
If the perforation rate is increased, mass transport limitations occur later in the operation of the electrochemical cell 100. This means, for example, that a higher current can be applied per cm² of active area of the electrochemical cell 100 without the cell itself degrading or delamination of a ceramic or other layer due to back pressure from media.
The performance of an electrochemical cell 100 can be significantly increased.
Ultimately, the cost per kW of the electrochemical cell 100 is also reduced.

1. A method for producing a diffusion layer (5, 6) for an electrochemical cell (100), wherein the diffusion layer (5, 6) includes a foil (5a, 6a), the method comprising hydraulically punching a plurality of holes (30) in the foil (5a, 6a).

2. The method according to claim 1,
wherein the foil (5a, 6a) is a metallic foil.

3. The method according to claim 1,
wherein several million holes (30) are punched in the foil (5a, 6a).

4. The method according to claim 1,
wherein the holes (30) are cylindrical.

5. The method according to claim 1,
wherein the hydraulic punching includes water punching.

6. The method according to claim 1,
wherein the hydraulic punching is carried out at a pressure of at least 10,000 bar.

7. The method according to claim 1,
wherein the holes (30) have a diameter (d) of at most 20 μm.

8. The method according to claim 1,
wherein the foil (5a, 6a) has a thickness(s) of at most 0.2 mm.

9. The method according to claim 1,
wherein the foil (5a, 6a) is clamped between a first die (31) and a second die (32) during punching, wherein a plurality of through-holes (33) is formed in the first die (31) corresponding to the plurality of holes (30) and which are fluidically connected to a pressure vessel (34) on one side and are fluidically connected to the holes (30) on the other side.

10. The method according to claim 9,
wherein a plurality of blind holes (36) is formed in the second die (32) corresponding to the plurality of holes (30), which blind holes are fluidically connected to the holes (30).

11. The method according to claim 10,
wherein the blind holes (36) are under a pressure which corresponds at most to atmospheric pressure at a start of the method.

12. A diffusion layer (5, 6) for an electrochemical cell (100),
wherein the diffusion layer (5, 6) has several million holes (30).

13. The diffusion layer (5, 6) according to claim 12,
wherein the holes (30) have a diameter (d) of at most 20 μm.

14. The diffusion layer (5, 6) according to claim 12,
wherein the holes (30) are cylindrical.

15. The diffusion layer (5, 6) according to claim 13, wherein the holes (30) are cylindrical.
